(19) United States
(12) Patent Application Publication
(10) Pub. No.: US 2023/0182108 A1
(43) Pub. Date: Jun. 15, 2023

(54) Method for manufacturing a multicapillary packing for a material exchange

(71) Applicant: SEPARATIVE, Solaize (FR)

(72) Inventor: François Parmentier, St Martin D'Heres (FR)

(21) Appl. No.: 17/924,100

(22) PCT Filed: May 21, 2021
(86) PCT No.: PCT/FR2021/050940

§ 371 Date: Nov. 8, 2022

(30) Foreign Application Priority Data
May 22, 2020 (FR) FR2005442

(51) Int. Cl. B01J 20/04; B01D 15/20; B33Y 80/00; B01J 20/10; B01J 20/08; B01J 20/12; B01J 20/283; B01J 20/284; B01J 20/28; B01J 20/30

(52) U.S. Cl. CPC B01J 20/045; B01D 15/20; B33Y 80/00; B01J 20/103; B01J 20/08; B01J 20/12; B01J 20/283; B01J 20/284; B01J 20/28085; B01J 20/28045; B01J 20/3007; B01J 20/3042; B29C 64/124

(57) ABSTRACT

The invention relates to a method for manufacturing a multicapillary packing for an exchange of material including the formation, by a 3D printing method, of a monolith having a porous mass through which a plurality of parallel channels passes, opening on an inlet face and an outlet face of the packing, the 3D printing method being chosen among: selective laser sintering, molten wire deposition, stereolithography, binder spraying and spraying of material, the porous mass being suitable for allowing the diffusion of material to be exchanged between the channels.

### CROSS-REFERENCE TO RELATED APPLICATIONS

This application is a U.S. National stage of International Patent Application No. PCT FR2021/050940 filed May 21, 2021, which claims the benefit of priority of French Patent Application No. 2005442 filed May 22, 2020, the respective disclosures of which are each incorporated herein by reference in their entireties.

### BACKGROUND

### Field of the Invention

The invention relates to a method for producing multicapillary packings for separating mixtures by material exchange, in particular by chromatography.

### Background of the Invention

The separating of mixtures by chromatography is currently mainly carried out on fine particle beds having a low permeability.

In order to improve the permeability of these beds, it is proposed to carry out these separations on assemblies of parallel capillary tubes carrying a stationary phase on their outer surface around a central passage that is empty of material, enabling the flow of the mobile phase. However, when these tubes are individualised, the difference in behaviour between the different independent channels causes a dispersion of the chromatography signal, which limits the ultimate efficiency of the device in terms of separator ability.

It is proposed to overcome this defect by allowing diffusive bridges between the channels, for example by forming said channels inside a porous mass.

Simple methods for producing such packings, in particular for analytical or preparative separations, still need to be found.

### SUMMARY

The invention relates to a method for manufacturing a multicapillary packing for a material exchange, in particular for chromatography, comprising the formation, by 3D printing, of a monolith comprising a porous mass through which a plurality of parallel channels passes, opening on an inlet face and an outlet face of the packing. Said porous mass, which constitutes the walls of the channels, is suitable for allowing the material to be exchanged to diffuse between the channels. For a chromatography application, said porous mass constitutes a stationary chromatographic phase or constitutes the support of a stationary chromatographic phase inserted in the pores of said porous mass.

Particularly advantageously, the method is carried out by one of the following 3D printing methods making it possible to obtain a high precision of the diameter of the channels, essential for a good material exchange. Indeed, it is known that too large a variability in the diameter of the channels, both within the same channel and between adjacent channels or channels of the structure, causes a reduction in the operational efficiency of the device:
selective laser sintering (SLS), used with mineral, polymer or metal powders, so as to produce a sintered material having pores. This porous sintered material can itself be a stationary phase or act as a base for depositing another material which will be a stationary phase, such as a silica gel, zeolite, organic gel or liquid for example,
fused deposition modelling (FDM), used with polymer mixtures and able to generate pores by dissolution, volatilisation or chemical attack of a component of the mixture; in particular, it is possible to produce a glass packing using this method [1] and, in particular, an alkaline borosilicate glass capable of exhibiting spinodal decomposition [2]. These borosilicate glasses enable the creation of porous glasses by add dissolution of a fraction resulting from a spinodal decomposition of such a glass, obtained by ripening at high temperature; this porous material can itself be a stationary phase or act as the basis for depositions of another material which can be a stationary phase, such as a silica gel, zeolite, organic gel or liquid for example,
stereolithography (which is intended here to cover the acronyms SLADLP/CLIP/DPP detailed below), preferably used with photo-crosslinkable or heat-crosslinkable organic gels containing a pore-forming agent leading to a porous structure of the crosslinking.
jetting a binder comprising at least one porous binder base, such as gypsum or cements, preferably used on inorganic or mineral precursors, such as alumina silica gels or powdery aluminosilicate, this porous material being able to be a stationary phase per se or acting as a base for depositing another material which can be a stationary phase, a silica gel, zeolite, organic gel or liquid for example, resulting in a porous material comprising at least one porous binder base, or
material jetting, in other words jetting of a porous material or a precursor of pores, preferably used with inorganic or organic precursors such as silica gels and their sol gel precursors or a liquid precursor mixture such as a soluble silicate, or a mixture containing alkoxysilane, or a colloidal sol, and a silica gel, alumina or powdery aluminosilicate, gypsum or cements, or organic gels, this porous material being able itself to be a stationary phase or acting as a base for depositing another material which can be a stationary phase, such as a silica gel, zeolite, organic gel or liquid for example.

In certain embodiments, the channels passing through the packing have a diameter less than 500 μm and are separated by walls of thickness less than 500 μm.

In certain embodiments, the method is carried out according to the binder jetting technique by jetting a binder onto a powder containing gypsum and a stationary phase for chromatography.

Said binder can comprise at least one colloidal suspension of silica sol, a boehmite sol or an aluminosilicate, such as a peptised clay.

In certain embodiments, the method is carried out according to the binder jetting or material jetting technique, wherein the jetted binder or material comprises at least one suspension of silica gel powder in a colloidal silica sol, an active alumina powder suspension such as an γ-alumina in a boehmite sol, or an aluminosilicate, such as a zeolite with a peptised clay.

In certain embodiments, the packing is formed with non-porous walls between the channels, and the pores of the packing are developed subsequently in a subsequent step of the method.

In certain embodiments, a stationary phase that is useful in chromatography is deposited in the pores of the wall.

In certain embodiments, the method is a stereolithography (SLA) method, wherein a porous organic gel is used as porous material.

In certain embodiments, the stationary phase that is useful in chromatography consists of a liquid carried by the pores of the monolith.

### BRIEF DESCRIPTION OF THE FIGURES

Other features and advantages of the invention will become apparent from the detailed description which follows with reference to the appended drawings in which:

FIG. 1 is a sectional view of a multicapillary packing according to an embodiment of the invention;

FIG. 2 is a view from above of a face of the packing of FIG. 1.

Said figures have not been drawn to scale and are presented by way of illustration only.

### DETAILED DESCRIPTION

According to the invention, a packing is produced by a method for constructing three-dimensional structures, known as 3D printing or additive manufacturing.

In general, a 3D printing method comprises the layer-by-layer production of a three-dimensional structure by jetting or by polymerising a solid, liquid or molten material.

Various 3D printing techniques exist, which are described below and which can all be used in order to form a packing for material exchange, in particular for chromatography.

In the present invention, a monolith is formed which is not only porous but also has channels which pass through from one side to the other. Said channels allow the flow of a mobile phase comprising the material to be exchanged or to be separated, and the porous wall separating the conduits enable a diffusion of material between adjacent conduits. In certain embodiments, the channels can be rectilinear, but they can alternatively be non-rectilinear, for example in the form of curved segments or portions, provided that each channel extends continuously through the monolith.

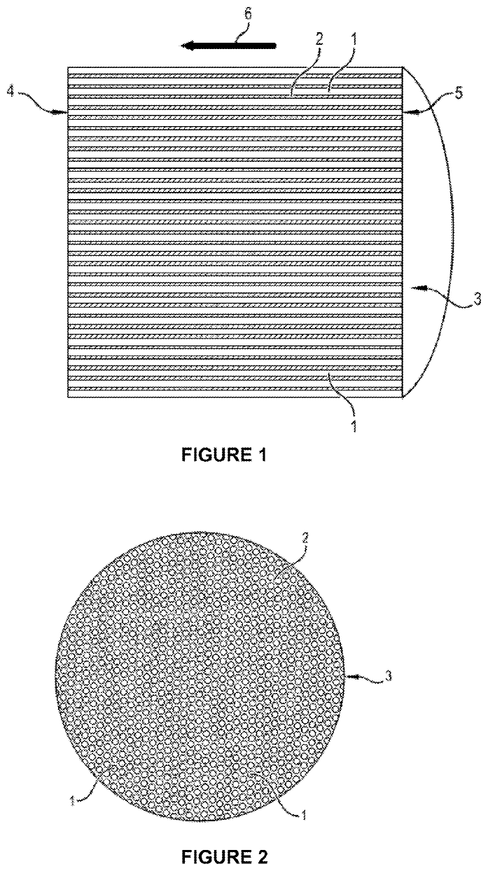

FIG. 1 is a sectional view of a cylindrical multicapillary packing according to an embodiment of the invention, in a direction perpendicular to its major axis.

It comprises a porous mass 2 and empty capillary channels 1 where a fluid passing through the packing 3 can circulate freely.

In the illustrated case, the capillary channels are straight, parallel and regularly spaced. Each channel passes through the monolith, in other words it has its ends on each side 4 and 5 of the cylindrical packing, enabling the circulation of the fluid from the inlet side to the outlet side.

FIG. 2 is a view from above of a face 5 of the cylindrical packing in the direction 6. The openings of the individual capillary channels 1 can be distinguished in the porous mass 2.

According to the invention, a packing is produced for material exchange by forming, by 3D printing, a monolith comprising channels passing through a porous mass.

Advantageously, the material exchange is carried out under conditions such that it results in a chromatographic separation method.

For this purpose, the material of said porous mass can constitute a stationary chromatographic phase or constitute the support of a stationary chromatographic phase inserted in the pores of said material. In a manner that is known per se, such a stationary phase is suitable for selectively retaining, in particular by adsorption, species contained in a mobile phase, so that the different species leave the packing at different times, which enables them to be collected separately.

According to the invention, the packing advantageously consists of channels of diameter less than 500 μm and separated by walls of a porous material, said walls having a thickness less than 500 μm.

According to the invention, this material can consist, in particular, of a porous solid, for example a porous organic gel, porous alumina, porous silica gel, porous zirconium oxide or porous titanium oxide. These materials constitute the stationary phases for the chromatography.

According to an embodiment of the invention, the porous solid passed through by the channels has, in its pores, inclusions of a porous organic gel, porous alumina or porous silica gel, which are stationary chromatographic phases. In this case, the porous solid which forms the support for the stationary phase can be neutral with regard to chromatographic separation, the separation function only being provided by the stationary phase included in the pores of said solid.

3D printing methods suitable for implementing the invention will now be described, said methods being known per se for the manufacture of various objects.

### A—Stereolithography

### A.1—Photopolymerisation (SLA, Acronym for Stereolithography Apparatus)

This technique generally uses a special resin bath that is sensitive to a laser photopolymerisation process. After solidification of each layer, the laser continues to heat the resin which hardens until the complete object is formed. This technique thus enables printing of transparent fused silica glasses.

This technique can be used, in particular, according to the invention with a heat-polymerisable or photopolymerisable liquid consisting of a monomer or oligomer base, or a mixture of such bases, and a pore-forming agent, such as an organic solvent.

### A.2. Digital Light Processing (DLP)

This technique consists of illuminating each layer of photopolymerisable resin by a single digital image. The result is a layer formed of small bricks called voxels (corresponding to the pixels of the digital image). This technique can be used according to the invention with a photopolymerisable liquid consisting of a monomer or oligomer base, or a mixture of such bases, and a pore-forming agent, such as an organic solvent.

### A.3—Continuous Liquid Interface Production (CLIP)

The liquid resin is solidified using an ultraviolet light image, causing photopolymerisation in an environment in which the oxygen content is controlled. The use of an image, rather than a laser, makes this printing technique one of the quickest on the market, reducing the printing time to several minutes instead of several hours for an object of the same size. This technique can be used according to the invention with a photopolymerisable liquid consisting of a monomer or oligomer base, or a mixture of such bases, and a pore-forming agent, such as an organic solvent.

### A.4—Daylight Polymer Printing (DPP)

This technique can also be called LCD 3D printing and consists of hardening the polymer using daylight or a liquid-crystal display (LCD).

This technique can be used according to the invention with a photopolymerisable liquid consisting of a monomer or oligomer base, or a mixture of such bases, and a pore-forming agent, such as an organic solvent.

### B—Powder Bed Fusion

### B.1—Selective Laser Sintering (SLS)

This technique is similar to stereolithography, but it uses a polymer powder instead of a liquid photopolymer. A powerful laser locally solidifies the powder surface and agglomerates it to the preceding layers by sintering. A new powder layer is then spread and the process recommences.

### B.2—Selective Laser Melting (SLM)

This is the most commonly used technique for making metal parts. It offers a good compromise between precision and dimensions.

The terms “Laser Beam Melting”, “Direct Metal Laser Sintering” designate the same method.

### B.3—Electron Beam Melting (EBM)

The EBM method uses an electron beam in place of the laser beam used in selective laser melting (SLM).

### C—Binder Jetting (BJ)

The 3D printing technique by binder jetting consists of depositing an adhesive binder in fine layers of powder material. The material can be ceramic-based (glass or gypsum, for example) or metal-based (stainless steel, for example).

### D—Fused Deposition Modelling (FDM)

This technique consists in melting a thermoplastic filament (generally an ABS or PLA plastic) through a heated nozzle at a temperature varying between 160 and 400° C. depending on the plasticity temperature of the polymer. The molten wire, with a diameter on the order of a tenth of a millimetre, is deposited on the model and sticks by remelting on the preceding layer.

### E—Material Jetting (MJ)

The 3D printing technique by material jetting is comparable to the conventional inkjet. The use of photopolymers, metals or waxes which solidify when they are exposed to light or to heat (in a similar manner to stereolithography) guarantees that the physical objects are manufactured one layer after another. Material jetting can print different materials, in 3D, in the same part.

This technique covers, in particular, the methods defined by the acronyms NPF (Nanoparticle jetting) and DOD (Drop on demand).

A packing produced according to any one of methods A to E can receive, in its pores, a porous organic gel for chromatography that is subsequently polymerised in situ, a silica gel, alumina gel, deposited in the form of colloidal suspensions that are subsequently dried or by a sol gel method, or an aluminosilicate such as a zeolite.

Advantageously, and in general, a packing with non-porous walls is produced by 3D printing, and the pores of the material are developed, forming said walls in a subsequent step of the method.

In particular, such pores can be developed by dissolving a soluble fraction of a polymer, metal or vitreous material constituting the walls, by vaporising a volatile fraction of the material constituting the walls, by selective liquid-phase or gas-phase chemical reaction such as an acid-base reaction, volatilisation by a halogen of a constituent of a metal, a mixture of metals or an alloy constituting the walls, an add attack by an acid such as nitric or hydrochloric acid of a constituent of a metal, mixture of metals or alloy constituting the walls, etc.

According to an embodiment of the invention, a stationary phase that is useful in chromatography is deposited in the pores of the wall. This deposition can be made by chemical vapour deposition, by dipping, by dipping following polymerisation, etc.

This stationary chromatographic phase can advantageously consist of a liquid.

According to an embodiment implementing an FDM technique, polymer filaments composed of at least two components, a structural component and an ablative component, are used. The ablative component will be removed during a subsequent step, so as to form pores in material.

In particular, it is possible to produce a packing made of glass [1] and, in particular, made of an alkaline borosilicate glass capable of exhibiting spinodal decomposition [2]. These borosilicate glasses enable the creation of porous glasses by acid dissolution of a fraction resulting from spinodal decomposition of such a glass, obtained by ripening at high temperature.

According to another embodiment, a packing produced by binder jetting can be produced by deposition from a liquid suspension of particles, subsequently dried and solidified. In reference [3] there is an exemplary embodiment of monoliths made of gypsum suitable for producing packings according to the invention.

In the context of a binder jetting technique, colloidal suspensions of silicon sols, boehrnite sols or aluminosilicates, such as peptised clays, are advantageously used as binder.

In the context of a binder jetting or material jetting technique, powder suspensions of silica gels in colloidal silica sols, powder suspensions of active alumina such as γ-alumina in boehmite sols, or aluminosilicates such as zeolites bound by day are advantageously used.

Alternatively, a stereolithography method (SLA/DLP/CLIP/DPP) can be carried out on a liquid consisting of monomer precursors of an organic gel, a heat-sensitive or photosensitive activator and a pore-forming agent.

In the context of an SLA method, or as stationary phase deposited subsequently in the pores of the monolith, a porous organic gel, defined in that it mainly consists of organic chemical species and therefore mainly consists of carbon and species usually bonded to carbon in the context of organic chemistry, and in that it has structural pores, is advantageously used as porous material. In particular, said gel mainly consists of a combination of a backbone of carbon atoms and hydrogen, oxygen, nitrogen, phosphorus, sulfur, chlorine, fluorine, bromine and iodine atoms. This includes hydrocarbon, halocarbon, hydroxycarbon, oxycarbon, sulfocarbon, phosphorocarbon, nitrocarbon species, etc., of natural or artificial origin.

This gel may consist of organometallic species without going beyond the scope of the invention. Atoms that can be used in the present invention, being part of the molecules of the organic gel, mainly include silicon, tin, lead, boron, aluminium, gallium, indium, zinc, beryllium, magnesium, titanium, zirconium, arsenic, antimony, selenium, etc.

In particular, the organic gel can comprise, in its mass, products that can be obtained by co-condensation of orthosilicates and organosilanes. These silanes can comprise one, two or three Si—C or Si—R bonds. R can be any carbon radical, such as a propyl, butyl, octyl or octadecyl radical, a primary, secondary, tertiary or quaternary amine, an alcohol, an organic acid, a reactive group, etc. In a non-limiting manner, one or more mono-, bi- or tri-functional silanes can be part of the structure. In a non-limiting manner, materials that can be used for the invention and constitute the porous material of the packing include gels of polyvinyl alcohol, polymethyl methacrylate, polyhydroxymethyl methacrylate, polyacrylamide, hydroxyethyl methacrylate copolymerised with glycidyl dimethacrylate (GMA-EDMA), etc.

The polyacrylamides advantageously consist of copolymers of acrylamide and N,N′-methylenebisacrylamide.

Also included are cellulose (a polysaccharide) and its derivatives, in particular carboxymethyl celluloses and diethylaminoethyl celluloses for ion-exchange chromatography.

It is also possible to use organic polysaccharide gels that are known in the art using organic macromolecules such as cross-linked dextrans, for example N,N-methylenediacrylamides or epichlorhydrins. These gels are known, in particular, under the trade names Sephacryl™ and Sephadex™, which are products from GE Healthcare.

It is also possible to use other organic polysaccharide gels using organic macromolecules such as cross-linked agaroses, for example epichlorhydrins. These gels are known, in particular, under the trade names Sepharose™ and Superdex™, Superose™, which are products from GE Healthcare.

It is also possible to use other organic gels using artificial macromolecules such as vinyl polymers containing many hydroxyl groups. These gels are known, in particular, under the trade name ToyoPearl™, which are products from the Tosoh group.

When the organic gel is itself included in the porous material, it can consist of low molecular weight molecules, i.e. advantageously less than 1000 g/mole, more advantageously less than 500 g/mole, and still more preferably less than 150 g/mole. These low molecular weight substances can, in this particular case, be organic liquids.

In the case of liquid phase chromatography, organic liquids that can be used as organic gel in order to implement the invention are, in particular, aldehydes, ketones (methyl ethyl ketone, methyl isobutyl ketone, methyl cyclohexanone, dimethyl cyclohexanone), esters (cyclohexyl acetate, furfuryl acetate, amyl acetate), ethers (2-chloro-2methoxy diethyl ether, diisopropyl ether) aliphatic and aromatic hydrocarbons (hexane, dodecane, and benzene, toluene) alcohols (isobutanol, pentanol, octanol, dodecanol, methyl cyclohexanol, 2-ethyl hexanol), carboxylic acids (octanoic acid, naphthenic acids). Other organic liquids can be used, such as tributyl phosphate, trioctyl phosphate, trioctyl phosphine oxide, phosphoric acid esters, dimethyl phthalate, diethyl oxalate, aryl sulfonic acids, hydroxyoximes, derivatives of oximes, beta diketones, alkylaryl sulfonamides, primary, secondary, tertiary, quaternary amines, etc.

In particular, the organic gels can be produced starting from mixtures of monofunctional monomers and multifunctional monomers. The multifunctional monomers cross-link the obtained polymer.

These organic gels can be prepared from mono-, di- and multifunctional monomers known in the prior art. These can be monomers containing epoxy, vinyl or hydroxyl siloxane radicals. This can be styrene and its derivatives containing hydroxyl, halogen, amino, sulfonic, carboxylic, NO2 groups, C4, C8, C12 or C18 alkyl chains, etc. These monomers can be acrylates, methacrylates, acrylamides, methacrylamides, vinylpyrolidones, vinylacetates, acrylic acid, methacrylic acid and vinyl sulfonic acids. The siloxanes can comprise a hydroxyl group, vinyl, alkyl groups etc.

The monofunctional monomer content can vary between 2% and 98% by weight of the total monomers.

Advantageously, it is between 2% and 40% by weight of the total monomers.

Bifunctional or multifonctional monomers can be monomers based on benzene, naphthalene, pyridine, alkyl ethylene, glycol, etc., comprising two or more functional vinyl or epoxy groups. Examples of these components are divinyl benzenes, divinyl naphthalene, alkoyl diacrylates and dimethacrylates, diacrylamides, and dimethylacrylamides, divinyl pyridines, dimethacrylates or ethylene glycol diacrylates, polyethylene glycol, trimethylolpropane dimethacrylate or trimethacrylate, 1,3 butanedioldiacrylate, pentaerytrithol di-, tri- or tetra- methacrylates or acrylates, or the mixtures thereof. Di-, tri- or tetrahydroxyl siloxanes, often generated from alkoxysilanes, can be used.

The bifunctional or monofunctional monomer content can vary between 100% and 2% by weight of the total monomers.

Advantageously, said content is between 98% and 60% by weight of the total monomers.

The initiators used for the polymerisation include all those included in the prior art, such as azo compounds and peroxides. Typical examples are azobisisobutyronitrile and benzoyl peroxide. The typical quantity of initiator in general varies from 0.4 to 2% by weight relative to the weight of monomers.

In the case of siloxanes, acid hydrolysis is preferred.

These mixtures are advantageously polymerised in the presence of a pore-forming agent that is subsequently removed, such as an organic solvent or a non-reactive polymer. This can include, in particular, dodecanol-1 and cyclohexanol-1.

The quantity of pore-forming agent can vary between 10 and 90% and preferably between 20 and 60% by volume of the final mixture comprising the monomers.

Such packings can be used in liquid, gas or supercritical-phase chromatography

### REFERENCES

[1] F. Kotz et al, Three-dimensional printing of transparent fused silica glass, Nature, vol. 544, 20 Apr. 2017, p. 337-339
[2] O. V. Mazurin and E. A. Porai-Koshits (Eds.), Phase separation in glass, North-Holland, Amsterdam, Oxford, N.Y., Tokyo, 1984
[3] U.S. Pat. No. 5,204,055

1. A method for manufacturing a multicapillary packing for a material exchange, comprising forming, by a 3D printing method, a monolith comprising a porous mass and a plurality of parallel channels passing through the porous mass, the channels opening on an inlet face and an outlet face of the packing,
the 3D printing method being chosen from: selective laser sintering, fused deposition modelling, stereolithography, binder jetting and material jetting,
said porous mass being adapted for allowing the material to be exchanged to diffuse between the channels.

2. The method according to claim 1, wherein the channels have a diameter less than 500 μm and are separated by walls of thickness less than 500 μm.

3. The method according to claim 1, wherein said porous mass constitutes a stationary chromatographic phase or constitutes the support of a stationary chromatographic phase inserted in the pores of said porous mass.

4. The method according to claim 3, wherein the stationary chromatographic phase is in the form of a liquid carried by the pores of the monolith.

5. The method according to claim 1, wherein the 3D printing method is the jetting of a binder onto a powder containing gypsum and, where appropriate, a stationary chromatographic phase.

6. The method according to claim 5, wherein the binder comprises at least one colloidal suspension of silica sol, a boehmite sol or an aluminosilicate, such as a peptised clay.

7. The method according to claim 1, characterised in that the 3D printing method is binder jetting or material jetting, wherein the jetted binder or material comprises at least one suspension of silica gel powder in a colloidal silica sol, an active alumina powder suspension such as an γ-alumina in a boehmite sol, or an aluminosilicate, such as a zeolite with a peptised day.

8. The method according to claim 1, wherein the monolith is formed with non-porous walls between the channels, and the pores of the monolith are developed in a subsequent step of the method.

9. The method according to claim 1, further comprising the depositing of a stationary chromatographic phase in the pores of the porous mass separating the channels.

10. The method according to claim 1, wherein the 3D printing method is stereolithography (SLA), wherein a porous organic gel is used as porous material.
